(19) United States
(12) Patent Application Publication
(10) Pub. No.: US 2025/0130187 A1
(43) Pub. Date: Apr. 24, 2025

(54) SYSTEMS AND METHODS FOR IN-PLANE CHARACTERIZATION OF ISOTROPIC AND ANISOTROPIC MATERIALS

(71) Applicant: Purdue Research Foundation, West Lafayette, IN (US)

(72) Inventors: Aalok U. Gaitonde, West Lafayette, IN (US); Aaditya A. Candadai, Chandler, AZ (US); Justin A. Weibel, West Lafayette, IN (US); Amy M. Marconnet, West Lafayette, IN (US)

(21) Appl. No.: 18/921,393

(22) Filed: Oct. 21, 2024

Related U.S. Application Data
(60) Provisional application No. 63/544,887, filed on Oct. 19, 2023.

(51) Int. Cl. G01N 25/18; G01J 5/00; G01J 5/0806

(52) U.S. Cl. CPC G01N 25/18; G01J 5/0806; G01J 2005/0077

(57) ABSTRACT

An apparatus for measuring a property of a material sample includes a heatsink, a heat source, and a two-dimensional transient thermal imaging system. The heatsink is configured to support a material sample at a fixed position thereon and to maintain a preconfigured contact temperature with the material sample. The heat source is configured to direct an input heat signal at a fixed position toward an opening of the heatsink toward the material sample. The two-dimensional transient thermal imaging system is configured to generate a resultant two-dimensional transient temperature distribution dataset associated with the material sample upon the heat source directing the input heat signal toward the opening to heat the material sample.

### CROSS-REFERENCE TO RELATED APPLICATIONS

This application is related to and claims the priority benefit of U.S. Provisional Patent Application No. 63/544,887, entitled “Systems and Methods for In-Plane Characterization of Isotropic and Anisotropic Materials,” filed Oct. 19, 2023, the contents of which are hereby incorporated by reference in their entirety into the present disclosure.

### TECHNICAL FIELD

The present application relates to measuring properties of materials, and more particularly to thermal, non-contact systems and methods of generating in-plane characterizations of isotropic and anisotropic materials.

### BACKGROUND

This section introduces aspects that may help facilitate a better understanding of the disclosure. Accordingly, these statements are to be read in this light and are not to be understood as admissions about what is or is not prior art.

Development and discovery of new materials is often a strong enabler of technological breakthroughs. Over the past decade, research efforts have led to the creation of unique thin material films, polymer fibers and composites, and battery materials. Many of these newly developed materials possess advantageous properties for various applications ranging from energy to health to electronics.

In certain applications, such as in electronics and semiconductor packages, high heat fluxes require these materials having high thermal conductivity to effectively diffuse the heat and avoid local hotspots. Engineered heat spreading materials typically exhibit anisotropic conduction behaviors due to their composite constructions. Design of thermal management solutions is often limited by the lack of fast and accurate characterization techniques for anisotropic materials. A specific interest for thermal engineering applications has been the broad potential impact of advanced materials with extreme and tunable thermal conductivity for both thermal insulation and heat spreading applications. For example, recent work has demonstrated several forms of graphene and carbon nanotube (CNT)-based films and sheets with ultra-high thermal conductivity for heat dissipation from electronic devices. Large-area graphene sheets having thermal conductivity greater than 1200 W m⁻¹K⁻¹ have been formulated using a roll-to-roll process, demonstrating superior hot spot dissipation compared to conventional heat spreaders. Super-aligned CNT films with different alignment configurations have been designed achieving tunable in-plane and cross-plane thermal conductivities. Two-dimensional nanomaterials such as few-layer black phosphorus have been shown to exhibit in-plane thermal anisotropy, providing guidance for the design of optoelectronic devices. There is also interest in the development of high thermal conductivity polymer fibers and composites for dielectric, flexible, and wearable heat spreading applications. Such materials inherently possess in-plane anisotropy with respect to thermal properties due to directional alignment and orientation of polymer chains. Ultra-drawn highly oriented polyethylene films with a thermal conductivity of up to 62 W m⁻¹K⁻¹ have been fabricated along the direction of drawing. Other works have demonstrated the construction of high in-plane thermal conductivity fabrics using woven yarns of ultra-high molecular weight polyethylene fiber, yielding a fabric with a thermal conductivity of up to ˜10 W⁻¹K⁻¹ along the high packing density direction. It was predicted that the effective thermal conductivity can range from ˜2-10 W m⁻¹K⁻¹ based on the directional packing density, indicating the potential to tune the in-plane thermal anisotropy for such fabrics.

In light of these recent material advancements, the development of complementary experimental measurement methods for characterization of in-plane anisotropic thermal properties becomes essential. There are only a few recent studies that have demonstrated measurement of in-plane anisotropic thermal conductivity. For few-layer black phosphorous, other studies utilized micro-Raman spectroscopy to measure the anisotropic thermal conductivity. Modified versions of the time-domain thermoreflectance (TDTR) technique have also recently been used to measure in-plane thermal anisotropy. Such techniques are limited to measuring very thin film materials (e.g., <10-100 μm) and require complex and expensive optical systems.

The Ångstrom method and laser-flash method are two other measurement techniques that can be used to measure the thermal properties of materials with simpler equipment. In the standard laser-flash method, a short pulse of energy heats one side of a flat sample uniformly, while the transient temperature rise of the opposite face is measured by a detector. This temperature profile is then used to calculate the thermal diffusivity of the sample. This technique assumes one-dimensional heat transfer across the thickness of the sample and is generally limited to the measurement of through-thickness thermal conductivity of bulk materials. This laser-flash technique can be adapted to measure in-plane thermal diffusivity of materials by applying a ring-shaped heating profile to one side of the sample, and measuring the transient temperature rise of the opposite side at the center of the ring. In the Angstrom method, one end of a long, thin strip of material is heated periodically, and the measurement of the temperature oscillations and phase delay at two different locations along the sample length can be used to extract the material thermal diffusivity. The analysis involves fitting of the experimental temperature measurements to a one-dimensional heat transfer model to calculate thermal diffusivity. Recent studies have focused on making this technique more versatile, accurate, and scalable to smaller sample dimensions with non-contact infrared microscopy-based measurement of temperatures. However, all prior Ångstrom methods are limited to measurements along a single direction and require multiple material strips to determine anisotropy of the material along different directions.

Therefore, there is a need to develop a measurement technique that enables in-plane thermal characterization of anisotropic materials across a range of different types and forms of materials.

### SUMMARY

Described herein are systems and methods which can improve measurement techniques for characterizing the isotropic and anisotropic in-plane thermal properties of materials, for example, thin films and sheets. The measurement can leverage non-contact infrared temperature mapping to measure the thermal response from laser-based periodic heating at the center of a suspended thin film sample.

In one embodiment, one such system for measuring a property of a material sample can include various components such as a heatsink, a heat source, and a thermal imaging system. The heatsink can be configured to support a material sample at a fixed position thereon and can be configured to maintain a preconfigured contact temperature with the material sample. Further, the heatsink can include an opening therethrough it. The heat source can be positioned adjacent to the heatsink and can be configured to direct an input heat signal at a fixed position through the opening toward the material sample. In some embodiments, the heat source can be operable to selectively tune the frequency and power of the input heat signal. Additionally, the thermal imaging system can be positioned adjacent to the heatsink and can be configured to generate a resultant two-dimensional transient temperature distribution dataset associated with the material sample upon the heat source directing the input heat signal through the opening to heat the material sample.

In some embodiments, the heat source can include a laser source and the input heat signal can include an input laser beam. The laser source can be operable to selectively tune the frequency and power of the input laser beam. In some examples, the input laser beam includes a periodic laser signal.

In further embodiments, the system can include a metallic laser absorber affixed to the material sample adjacent to the opening of the heatsink such that the input laser beam can be directed onto the metallic laser absorber. In other embodiments, the system can include a vacuum chamber for housing the heatsink and material sample during measurements.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts a schematic diagram of one exemplary system for generating in-plane characterizations of isotropic and anisotropic materials;

FIG. 1B depicts a schematic diagram of an alternative system for generating in-plane characterizations of isotropic and anisotropic materials;

FIG. 1C depicts a schematic diagram of the bottom view of the sample of FIG. 1A;

FIG. 1D depicts a pair of graphical diagrams showing time-periodic temperature responses at four different points at increasing distances away from a location of periodic laser heat input, the heating power corresponding to the first harmonic of the square wave profile applied to the laser source;

FIG. 2A depicts a photograph of one example system for generating in-plane characterizations of isotropic and anisotropic materials, showing the system with the convection shield removed for clarity;

FIG. 2B depicts a cross-sectional schematic view corresponding to cutting plane A-A of FIG. 2A, showing a sample positioned between two copper plates which are fastened to a temperature-controlled heatsink;

FIG. 3A depicts a schematic top view of a meshed geometry of a numerical thermal conduction model;

FIG. 3B depicts a cross-sectional view of the numerical thermal conduction model of FIG. 3A taken at cutting plane A-A of FIG. 3A, showing labelled boundary conditions assigned to the components for performing numerical experiments;

FIG. 4A depicts a graphical representation of an analysis of numerical simulations for a sample with in-plane anisotropic thermal conductivity: kₓ=2 W m⁻¹K⁻¹ and k_{y=}6 W m⁻¹K⁻¹, showing a top surface temperature map from the numerical simulations at a time instant to during the steady periodic temperature oscillations;

FIG. 4B depicts a graphical representation of the analysis of numerical simulations of FIG. 4A, showing the extracted map kx (x,y) obtained individually at each point in the domain, showing dashed circles to indicate the inner and outer boundaries representing the edge of the laser absorber and the edge of the heatsink, respectively;

FIG. 4C depicts a graphical representation of the analysis of numerical simulations of FIG. 4A, showing the extracted map kₓ(x,y) obtained individually at each point in the domain, showing dashed circles to indicate the inner and outer boundaries representing the edge of the laser absorber and the edge of the heatsink, respectively;

FIG. 4D depicts a graphical representation of an evolution of temperature with time at points A and B of the numerical simulation of FIG. 4A;

FIG. 5A depicts a graphical representation of an analysis of numerical simulations for a sample with in-plane anisotropic thermal conductivity kₓ=2 W m⁻¹K⁻¹and k_{y}=2 W m⁻¹K⁻¹, showing a top surface temperature map from the numerical simulations at a time instant to during the steady periodic temperature oscillations;

FIG. 5B depicts a graphical representation of the analysis of numerical simulations of FIG. 5A, showing the extracted map kₓ(x,y) obtained individually at each point in the domain, showing dashed circles to indicate the inner and outer boundaries representing the edge of the laser absorber and the edge of the heatsink, respectively;

FIG. 5C depicts a graphical representation of the analysis of numerical simulations of FIG. 5A, showing the extracted map k_{y}(x,y) obtained individually at each point in the domain, showing dashed circles to indicate the inner and outer boundaries representing the edge of the laser absorber and the edge of the heatsink, respectively;

FIG. 5D depicts a graphical representation of an evolution of temperature with time at points A and B of the numerical simulation of FIG. 5A;

FIG. 6A depicts a pair of graphical representations of a one-dimensional analysis of the isotropic example numerical experiment data for the case of the in-plane isotropic sample with kₓ=2 W m⁻¹K⁻¹and k_{y}=2 W m⁻¹K⁻¹, showing temperature amplitude and phase difference as a function of radial distance from the edge of the metal tape disk averaged over 360;

FIG. 6B depicts a graphical representation of the data from the fitting region between the two vertical dashed lines of FIG. 6A being used to fit for the thermal conductivity of the sample along with 10% sensitivity bounds;

FIG. 7A depicts a graphical representation of periodic heating frequency bounds depending on the in-plane and through-plane thermal conductivity of a sample at a fixed value of thickness and outer radius of the experimental setup, showing an example case corresponding to k_{x,y}=4 W m⁻¹K⁻¹ and k_{z}=0.5 W m⁻¹K⁻¹ as indicated by the pair of x points;

FIG. 7B depicts a graphical representation of a numerical experiment input (o symbols) and extracted (x symbols) thermal conductivities for a variety of combinations of in-plane orthotropic thermal conductivities along the x and y directions;

FIG. 8A depicts a graphical representation of two-dimensional temperature distribution on the top surface of a PTFE sample at a time instant t₀;

FIG. 8B depicts a graphical representation of the transient temperature responses at two discrete locations of the sample of FIG. 8A, point A on the right edge of the laser absorber and point B at the top edge of the laser absorber;

FIG. 8C depicts a graphical representation of experimentally measured values of thermal conductivity in the two in-plane orthotropic direction (kₓ and k_{y}) as a function of the heating frequency, the symbols denoting the mean thermal conductivity measured at a particular heating frequency and the error-bars denoting the uncertainty in the measurement, the shaded light red horizontal bands representing the expected range of thermal conductivity of PTFE;

FIG. 9A depicts a graphical representation of two-dimensional temperature distribution on the top surface of the Temprion OHS sample at a time instant t₀;

FIG. 9B depicts a graphical representation of the transient temperature responses at two discrete locations of the sample of FIG. 9A, point A on the right edge of the laser absorber and point B at the top edge of the laser absorber;

FIG. 9C depicts a graphical representation of experimentally measured values of thermal conductivity in the two in-plane orthotropic direction (kₓ and k_{y}) for a 45 μm thick sheet of Temprion OHS at various heating frequencies, both values of kₓ and k_{y} being fit simultaneously in a temperature dataset at that particular frequency, the symbols denoting the mean thermal conductivity measured at a particular heating frequency, and the error bars denoting the uncertainty in the measurement;

FIG. 10 depicts a flowchart representation of one example workflow method for selecting experimental parameters for the measurement of unknown materials using a laser-based Ångstrom method for the in-plane thermal conductivity measurement of sheet-like materials; and

FIG. 11 depicts a flowchart representation of one example workflow method for extracting unknown kₓ and k_{y} variables from the measured temperature data using a laser-based Ångstrom method for in-plane thermal conductivity measurement of sheet-like materials.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Overview

A few techniques explore the use of lock-in infrared thermography for the measurement of thermophysical properties of thin films and plates by using the response of the material to periodic heating. One such technique uses a heat source, for example a pulsating laser heat source, and rasterizes across a sample surface while the temperature of the backside of the sample is measured using thermography (e.g., IR thermography). Another technique uses a similar approach where periodic heating is achieved using halogen lamps and suitable optics. Another technique is based on lock-in thermography where temperature measurements are performed using thermocouples. While some of these techniques are capable of measuring in-plane thermal anisotropy, they involve moving the heat source across the sample using optical and mechanical apparatus and assume uniform absorption of the laser radiation across the surface. This assumption may not be true for samples that may have varying surface properties such as those of composite materials. Some of these methods are therefore limited to measuring low anisotropy ratios in the in-plane direction, while others can only resolve anisotropy across the in-plane and through-plane directions. More recently, in-plane thermal conductivity is measured using a beam-offset frequency domain thermoreflectance technique. Such techniques are capable of measuring the full thermal conductivity tensor for transversely anisotropic materials. However, they are typically limited to measuring an in-plane anisotropy ratio of up to ˜10. It has also been reported that the measurement uncertainty for low conductivity materials can be influenced by the pump beam radius and lateral heat spreading in the thin metallic transducer layer that needs to be applied for such thermoreflectance-based methods.

Described herein is an advantageous characterization technique which quantifies the anisotropic in-plane thermal properties of freestanding thin films and sheets of material. Generally, the sample is heated periodically at one fixed central point while two-dimensional transient temperature mapping measures the resulting two-dimensional in-plane temperature field in a non-contact fashion. The technique described herein provides multi-dimensional analysis with the ability to characterize in-plane anisotropic thermal properties of materials such thin heat spreaders, composite films, and fabrics across a wide range of thermal conductivities and anisotropy ratios. The principle of this technique, its experimental implementation, and associated numerical models for extraction of the desired material properties are described in greater detail below.

### II. Exemplary Measurement Techniques

A. One Example Experimental Configuration for Measuring Thermal

Properties of a Material

The measurement technique described herein extends the principles of the Ångstrom method to two dimensions to extract the in-plane thermal properties of a material based on the measured temperature response when subjected to periodic heating. The basic principle of the one-dimensional Ångstrom method is that the amplitude and phase lag of the time-periodic temperature oscillations in the material are sensitive to the thermal diffusivity. Extension of this principle to an in-plane two-dimensional temperature distribution allows in-plane anisotropic thermal property characterization for sample geometries such as films, sheets, and fabrics. A discretized form of the heat diffusion equation in the frequency domain is used to evaluate throughout the spatial domain to extract the unknown thermal properties from the measured time-periodic material temperature distribution (without solving the differential equation). Since the thermal properties extraction is based on the amplitude of oscillations and phase lag of the temperature signals, this measurement is independent of the laser power, the periodic heating frequency, or the precise boundary condition at the edge of the suspended sample. The technique therefore targets measurement of the in-plane anisotropic thermal properties, with the anisotropy defined based on different thermal conductivities along the orthotropic directions.

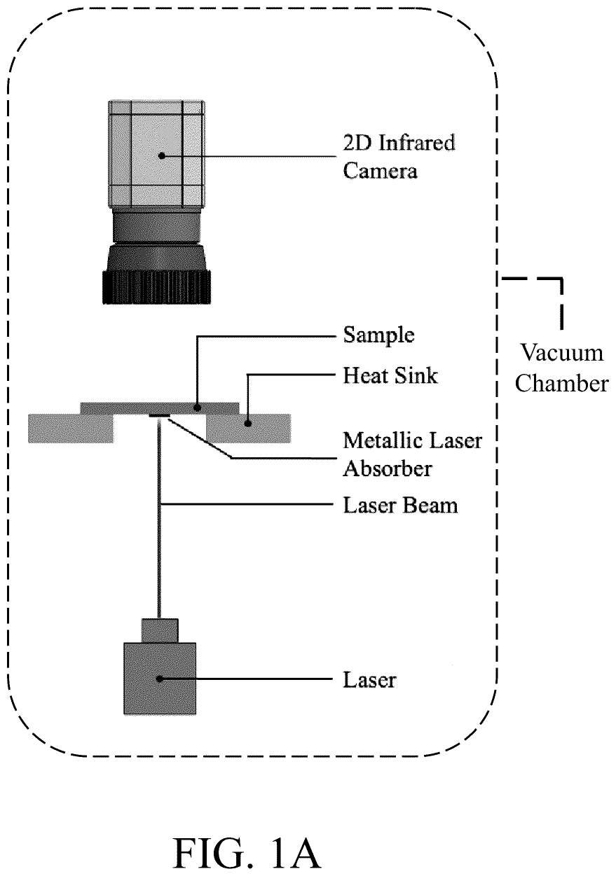

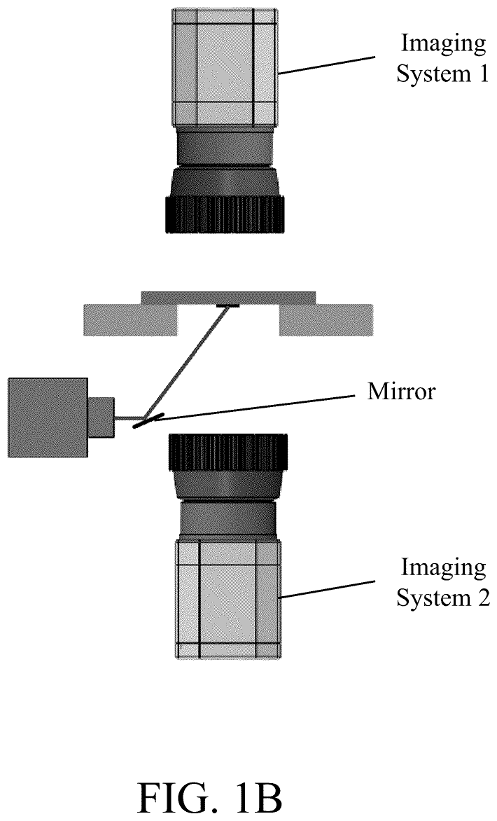

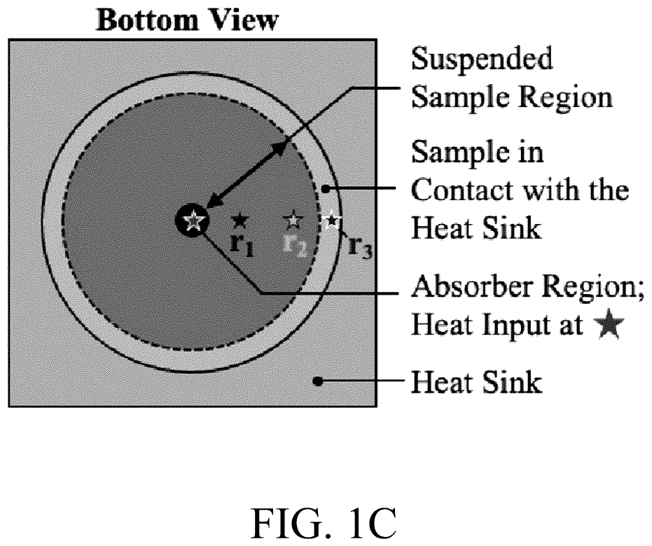

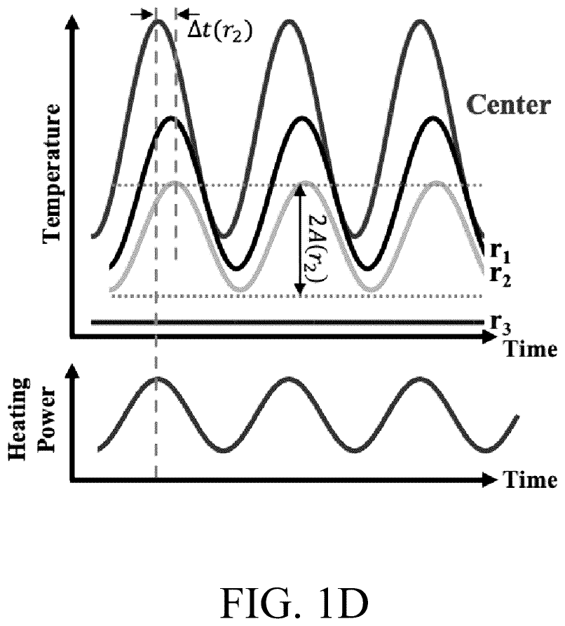

FIGS. 1A-1C show schematics of one example experimental system for measuring thermal properties of a material. A periodic heat input is applied to the bottom surface of a suspended sample, such as at the center of the sample, using a laser source and the two-dimensional transient temperature distribution of the top surface of the sample is measured using a two-dimensional transient thermal imaging system, such as an infrared (IR) camera. Particularly, the sample is suspended over a cylindrical hole in a heatsink that maintains the outer portion of the sample contacting the fixture at a consistent temperature, such as close to room temperature or at the temperature of the fluid flowing through the heatsink. A small central spot on the bottom surface of the sample is heated using a laser beam. A laser driver connected to a function generator provides a heat input, such as a modulated square-wave periodic heat input. The transient time-periodic temperature response of the entire top surface of the sample is measured using an IR camera. In some embodiments of use, such as for low conductivity materials, the components of the measurement system and the sample may be placed inside a vacuum chamber during the measurement to minimize losses.

A thin graphite coated circular metal disk can optionally be attached via an adhesive to the bottom surface of the sample to act as an absorber for the incident laser beam. The absorber serves several practical purposes, such as to absorb a large fraction of the incident laser power regardless of sample surface properties, to ensure the heated area is approximately circular, mitigating the effect of any eccentricity of the beam spot, and to prevent any laser radiation from transmitting through the sample and damaging the infrared detector. In principle, for fully opaque samples, the absorber disk can be eliminated.

This experimental setup of FIG. 1A allows for non-contact temperature sensing in the suspended sample region. It should be noted that the laser beam remains stationary, and the laser irradiation is incident on a fixed point on the laser absorber throughout the experiment. In alternative embodiments, the laser source and laser beam can be substituted with another non-contact heat source, or alternatively a contact-type heat source which directly contacts the sample to provide the same heating functionality as does the laser beam described herein. In still other embodiments, such as the embodiment shown in FIG. 1B, the heating configuration can include one or more mirrors or similar heat redirection elements to redirect the heating element (i.e., the laser beam) through an alternative path. Such an alternative configuration may be utilized for various reasons, such as to require less space for the component layout and/or to shift one or more components to allow for an additional two-dimensional transient thermal imaging system to image the opposite side of the material sample as the first two-dimensional transient thermal imaging system. Additionally or alternatively, the described measurement system may be positioned adjacent to an assembly line of moving material samples and configured to perform thermal heating and measurements while the material samples are moving or during a brief pause of the assembly line.

During a measurement, the sample is heated at a set frequency and power that are controlled using a frequency generator and by adjusting the power of the laser, respectively. The sample temperature response is then allowed to reach a steady periodic state, after which temperature is recorded as a function of space and time. Typically, ˜5-10 periods of the temperature oscillation are recorded to perform the subsequent data analysis. As illustrated in FIG. 1D, with reference to noted points shown in FIG. 1C, the temperature response gradually decreases in amplitude and increases in phase delay (illustrated by the time delay in the peaks, At, with increasing distance from the point of laser incidence). While FIG. 1D shows a sinusoidal heating power, experimentally, a square wave heating signal can instead be used for simplicity of controlling the laser. Then, using Fourier transforms, the amplitude and phase of the first harmonic of the temperature response, which has the highest amplitude, is analyzed to extract thermal conductivity. Assuming that the temperature dependence of thermal conductivity has negligible effect within the range of temperature oscillations, the form of the heat source profile has minimal influence on estimating thermal conductivity. In the following section, it is described how the experimental data is combined with an associated thermal analysis to yield the in-plane thermal properties of the sample.

### B. Exemplary Data Analysis Methods for Material Property Extraction

The following subsection presents one data analysis method which can be used to extract the thermal properties of a sample from the steady periodic temperature response. Described is an inverse method that determines the unknown in-plane thermal properties that cause the temperature response to best satisfy the governing heat conduction equations. Notably, the method does not require the knowledge of laser power input, through-plane thermal conductivity, or the temperature of the heatsink boundary condition to extract the in-plane anisotropic thermal conductivity.

### i. One Example 2D Approach for Characterizing Anisotropic Materials

The below method analyzes the transient two-dimensional temperature profile, T(x,y,t), of the top surface of the sample in the suspended domain between the edge of the metal absorber disk and the edge of the heatsink, as shown in the bottom view of the schematic in FIG. 1C. The temperature response should satisfy the governing heat diffusion equation assuming 2D in-plane heat conduction:

$$\frac{\partial }{\partial x} ( {k}_{x} \frac{\partial T}{\partial x} ) + \frac{\partial }{\partial y} ( {k}_{y} \frac{\partial T}{\partial y} ) = ρ {C}_{p} \frac{\partial T}{\partial t} . \qquad ( hereinafter , “ Equation 1 ” )$$

This form of Equation 1 allows for thermal conductivity to differ in the in-plane coordinate directions as k=kₓ\hat{x}+k_{y}ŷ. This analysis also assumes, by nature of a two-dimensional conduction equation, that the temperature is uniform across the sample thickness such that k_{z} does not factor into the analysis. As the temperature data analyzed are collected under steady periodic conditions, a time-periodic temperature solution is assumed for the suspended domain, which can be written in complex form in the frequency domain as:

$$T ( x , y , t ) = [ P ( x , y ) + iQ ( x , y ) ] {e}^{i ω t} \qquad ( hereinafter , “ Equation 2 ” )$$

where P(x, y) and Q(x, y) represent the real and imaginary parts of the complex amplitude, and e^{iωt} accounts for the periodic behavior of the solution with ω=2πf representing the angular frequency of the periodic heat input. Substituting this general solution for temperature into Equation 1, and equating the real and imaginary parts, the following set of partial differential equations are obtained for P and Q:

$${k}_{x} \frac{{\partial }^{2} P}{\partial {x}^{2}} + {k}_{y} \frac{{\partial }^{2} P}{\partial {y}^{2}} = - ρ {C}_{p} ω Q \\ {k}_{x} \frac{{\partial }^{2} Q}{\partial {x}^{2}} + {k}_{y} \frac{{\partial }^{2} Q}{\partial {y}^{2}} = ρ {C}_{p} ω P . \qquad ( hereinafter “ Equation 3 ” and “ Equation 4 ” , respectively )$$

The above equations are valid at each pixel in the domain. They can be solved as simultaneous algebraic equations based on computation of the second order partial derivatives for P and Q locally at each point in the domain from the experimental data to obtain a map of kₓ(x,y) and k_{y}(x,y). Alternatively, assuming that the material should be homogeneous through the domain, these can also be solved as a system of algebraic equations across all the points inside the domain, say n points, as shown below:

$${[ \begin{matrix}\frac{{\partial }^{2} {P}_{1}}{\partial {x}^{2}} & \frac{{\partial }^{2} {P}_{1}}{\partial {y}^{2}} \\ … & … \\ … & … \\ \frac{{\partial }^{2 {Q}_{1}}}{\partial {x}^{2}} & \frac{{\partial }^{2} {Q}_{1}}{\partial {y}^{2}} \\ … & … \\ … & …\end{matrix} ]}_{2 n \times 2} [ \begin{matrix}{k}_{x} \\ {k}_{y}\end{matrix} ] = ρ {C}_{p} {ω [ \begin{matrix}- {Q}_{1} \\ … \\ … \\ {P}_{1} \\ … \\ …\end{matrix} ]}_{2 n \times 1} . \qquad ( hereinafter , “ Equation 5 ” )$$

The steady periodic temperature response of the sample Tₑₓₚ(x,y,t) is processed using a Fourier transform at each point in the domain to obtain the in-phase and out-of-phase components at the fundamental frequency (frequency of periodic heating), which correspond to the spatially varying real (P) and imaginary (Q)) parts of the temperature amplitude signal at each pixel. To reduce uncertainty in the measurement, a magnitude threshold (e.g., 0.5 to 1° C.) can be defined for the amplitude of oscillation and any data points in the domain where the temperature amplitude is below this threshold can be omitted from the analysis. Using the built in gradient operator in MATLAB, the second-order partial derivatives of P and Q), with respect to x and y can be computed numerically. To reduce the amplification of spatial noise in the calculated partial derivatives, a convolution filter can be applied between successive gradient operations, using an square kernel of a size ranging from 5×5 to 11×11 pixels. Data can be processed at any chosen collection of points in the domain to fit single values of kₓ and k_{y} using Equation 5 that best fit their collective temperature response. This analysis is implemented using MATLAB to calculate the quantities kₓ and k_{y}, such that it minimizes the objective function given by ∥[PQ]·[k]−[pq]∥, where [PQ] represents the coefficient matrix on the left hand side of Equation 5, [pq] represents the matrix on the right hand side of Equation 5, [k] represents the orthotropic thermal conductivity matrix, and ∥ denotes the Euclidean norm. Note that in the absence of the explicit knowledge of ρ and cₚ, Equation 5 can be divided by the term ρcₚ and the thermal diffusivity values αₓ and α_{y} can be fit directly.

As noted above, the approach is valid assuming the temperature gradients along the through-thickness direction of the sample in the region analyzed are negligible compared to the gradients in the in-plane direction. An advantage of this approach is that the boundary conditions do not need to be specifically measured or accounted for in the model provided that the region of analysis does not closely approach the boundaries. Hence, the points chosen to fit for the in-plane thermal conductivities in the current configuration can be be sufficiently far away from the inner heating and outer heatsink boundary conditions. The validity of these assumptions depends on various parametric considerations relating to the sample and the measurement setup.

### ii. One Example of a One-Dimensional Radial Approach for Isotropic Materials

For the general case of an anisotropic material, the transient heat diffusion equation has no simple analytical solution, and the two-dimensional data analysis technique described above may be used. However, if the thermal conductivity in the in-plane direction is isotropic, an analytical solution for the temperature response in radial coordinates can also be used for inferring the thermal conductivity from the measurement data. The model of the linear Ångstrom method can be extended to a radial coordinate system to determine the in-plane thermal diffusivity (and therefore thermal conductivity) of the sample using an analytical approach.

The one-dimensional transient heat diffusion equation in radial coordinates is given below:

$$\frac{{\partial }^{2} T}{\partial {r}^{2}} + \frac{1}{r} \frac{\partial T}{\partial r} = \frac{1}{α} \frac{\partial T}{\partial t} . \qquad ( hereinafter , “ Equation 6 ” )$$

The boundary conditions considered are temperature oscillations in complex form with fixed amplitudes Tₐ and T_{b} at two respective radial locations r=a and r=b inside the sample domain, and a phase lag φ_{b} between them:

$$T ( r = a , t ) = \frac{{T}_{a}}{2} {e}^{i ω t} + \frac{{T}_{a}}{2} {e}^{- i ω t} , and \qquad ( hereinafter , “ Equation 7 ” )$$

$$T ( r = b , t ) = \frac{{T}_{b}}{2} {e}^{i ( ω t - {ϕ}_{b} )} + \frac{{T}_{b}}{2} {e}^{- i ( ω t + {ϕ}_{b} )} . \qquad ( hereinafter , “ Equation 8 ” )$$

Note that such boundary conditions can be selected at multiple radial locations due to the availability of high-resolution transient temperature data availability throughout the sample surface from the IR imaging.

A general periodic solution for the temperature profile in frequency domain can be written as:

$$T ( r , t ) = {T}_{1} ( r ) {e}^{i ω t} + {T}_{2} ( r ) {e}^{- i ω t} . \qquad ( hereinafter “ Equation 9 ” )$$

Here, T₁(r) and T₂(r) represent general complex functions which can be solved by substituting back into the governing equation and are in the form of Bessel functions, J₀ and Y₀, of the periodic heating frequency w and the in-plane thermal diffusivity α. Therefore, an analytical solution for the temperature profile can be obtained if the parameters Tₐ, T_{b}, and φ_{b} are known. These parameters can be taken from the experimental data for a given sample of interest to obtain an analytical solution of the steady periodic radial temperature profile. The unknown in-plane thermal diffusivity a of the sample (and hence thermal conductivity k) is determined by fitting the analytical solution to the experimental temperature profile at a given periodic heating frequency based on the steady periodic amplitude A(r) and phase φ(r) of the temperature oscillations. A fitting function that combines A(r) and φ(r) of the form

$$f ( {( r - {r}_{o} )}^{2} ) = ln \frac{{A}_{0}}{A ( r )} ( {ϕ}_{0} - ϕ ( {r}_{) )}$$

yields the thermal diffusivity of the sample.

### C. One Example Experimental Facility

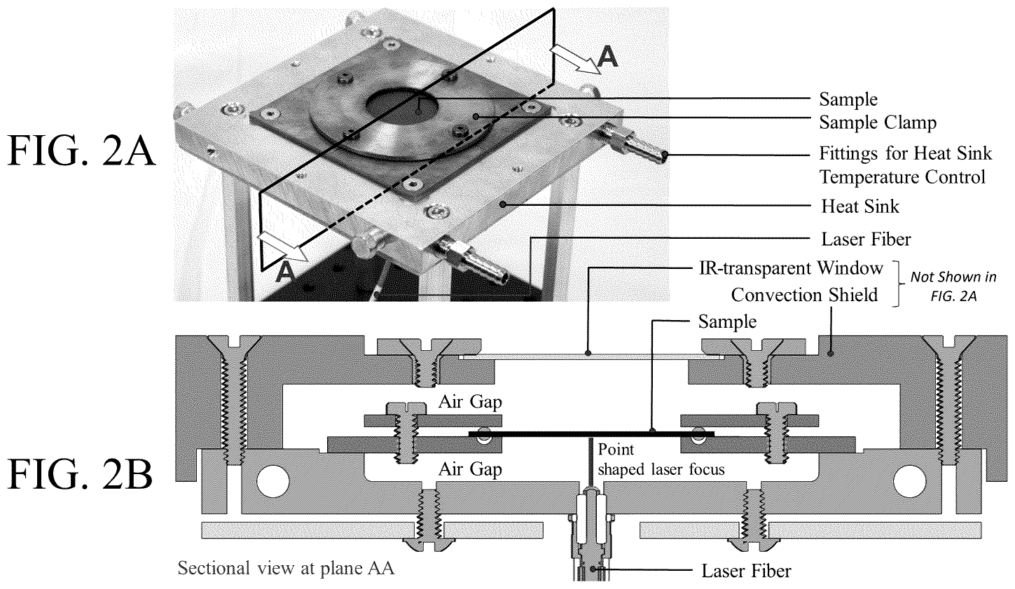

An experimental facility is developed to demonstrate this measurement technique. FIG. 2A shows a photograph of the assembled setup, while FIG. 2B shows a cross-section view of a three-dimensional drawing of the experimental assembly of FIG. 2A. In this setup, the sample is sandwiched between two copper plates with holes in the center that expose the top and bottom sides of the suspended sample. The bottom copper plate has an annular o-ring groove which aids in removing slack from flexible or thin samples using compression of an O-ring placed in this groove. The bottom copper plate is secured to a temperature-controlled aluminum mounting plate. Temperature control, if required to characterize at heatsink temperatures above/below ambient, can be achieved by circulating fluid of a known temperature from a chiller through internal channels in the mounting plate.

After the sample is mounted between the copper plates, it is coated with a thin layer of colloidal graphite (e.g., Isopropanol Base Graphite manufactured by Ted Pella, Inc. of Redding, California) having an emissivity of ˜0.8 for purposes of IR imaging. A graphite-coated thin aluminum disk (e.g., cut from an adhesive tape with an aluminum substrate) can be attached at the center of the bottom sample face to absorb the incident laser power and provide a uniform, circular heat source. In principle, for high-emissivity and opaque samples, these steps (i.e., the graphite coating and transducer attachment) are optional.

The suspended sample is heated periodically with a fiber-coupled diode laser (e.g., using a BWTek BWF2, 980 nm, max 5 W continuous wave) from the bottom. A square wave laser heating profile at the desired frequency is achieved by modulating the laser output using a function generator. The output laser fiber is secured rigidly to the aluminum mounting plate using a threaded sub-miniature, version-A (SMA) adapter to ensure alignment of the laser heat source to the center of the sample under test.

The assembly may be enclosed from above by an additively manufactured polymer shield to minimize the convective losses from the sample during experiments. The shield houses a Calcium Fluoride (CaF₂) window, which is nearly fully transparent across the 2-5 μm infrared spectrum, matching the range of the IR microscope detector sensitivity. Note that neither the convection shield nor the CaF₂ window are in thermal contact with the sample, and there exists an air gap between the shield and the sample. This arrangement enables the temperature measurements of the top surface of the sample to be performed using an IR camera. In this work, an infrared microscope (e.g., an INFRASCOPE manufactured by the Quantum Focus Instruments Corporation of Vista, California) is used. The interchangeable lenses on this microscope allow for measurements at various spatial resolutions, with an imaging field of view of 1024×1024 pixels. For the measurements reported in this work, a 1/6× magnification infrared lens is used, which corresponds to a spatial resolution of ˜75 μm/pixel and provides a sufficiently large field of view of ˜77×77 mm to measure the surface temperature response of the sample.

### III. Example Numerical Experiments for Measurement Technique Validation

### A. Introduction to Certain Numerical Experiments

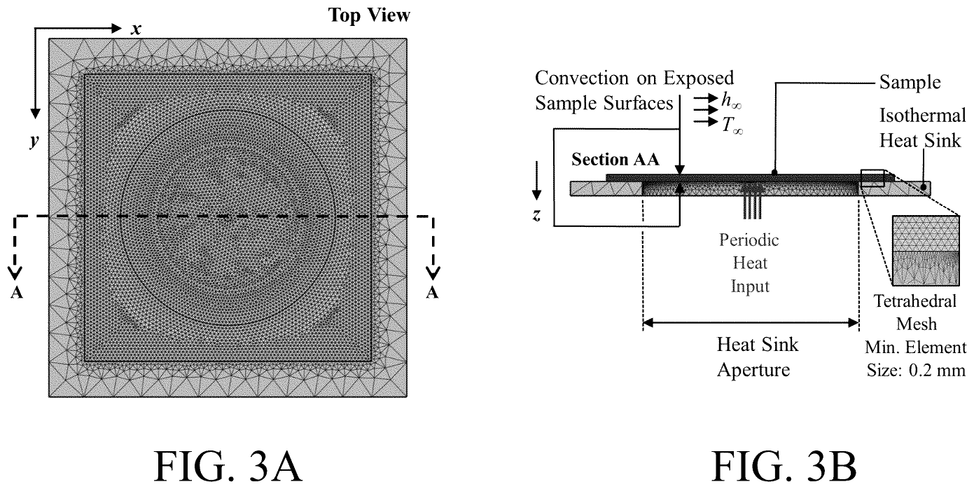

To validate the described measurement technique and guide the design of the experimental facility, a numerical thermal conduction model of the system is developed to generate simulated data. A 3D model geometry containing the salient features of the experimental setup in which thermal conduction must be simulated, including the suspended sample and an aluminum heatsink with a cylindrical hole is modelled with appropriate boundary conditions, as shown in FIG. 3A. A thin aluminum disk of diameter 5 mm is attached to the bottom surface of the sample. Note that neither the absorption properties of this material nor contact resistance between the disk and the sample are important, as the in-plane thermal properties of the sample are determined only from the transient thermal response of the sample in the suspended domain away from the heat source and heatsink, and independent of exact knowledge of the heat input or absorbed laser power. A periodic heat flux condition is assigned to the central ˜1 mm diameter region of the aluminum disk in the form q″(t)=q″ₒ(1+sin(2πf/^{t})), where q″ₒ is the laser heat flux, f is the periodic heating frequency, and t is time. A fixed temperature boundary condition is assigned to the aluminum heatsink.

The material properties of the sample including its density p, specific heat Cₚ, and anisotropic thermal conductivity (kₓ, k_{y}, and k_{z}) are specified as inputs to the model. Here, kₓ and k_{y} represent the thermal conductivities along the x and y in-plane orthotropic directions, while k_{z} represents the through-plane thermal conductivity.

The output of the numerical experiments is the simulated transient temperature data exported from the top surface of the sample at a regular grid of points that mimic the spatial temperature data collected by the infrared microscope. As illustrated by the data processing workflow shown in FIG. 3B, the numerical experiments provide a transient surface temperature map Tₑₓₚ(x,y,t) similar to what would be measured in a real experiment. This data set can then be processed using the data analysis method introduced above for extraction of the in-plane thermal conductivities of the sample, kₓ and k_{y}. The extracted properties can then be compared to the numerical model inputs to validate that the proposed measurement technique can determine the orthotropic in-plane thermal conductivities of a material, independent of its through-plane conductivity and input power.

In the following subsection, the results of the proposed measurement method and the data analysis approach are presented by analyzing representative numerical experiments for anisotropic and isotropic materials.

### B. Example Measurement Validation Methods for an Anisotropic Material

A fictitious in-plane anisotropic sample that is 500 um thick with thermal conductivities kₓ=2 W m⁻¹K⁻¹1, k_{y}=6 W⁻¹⁻¹, and k=0.5 W m⁻¹K⁻¹, density ρ=970kg m⁻³, and specific heat capacity cₚ=1950 J kg⁻¹K⁻¹ is considered. Numerical experiments are performed using this sample and the data are analyzed using the general 2D approach as described above. The input heat flux is q″₀=5×10⁵ W m⁻at a frequency of f=25 mHz, and a total of 25 periods with 100 time steps in each period are simulated.

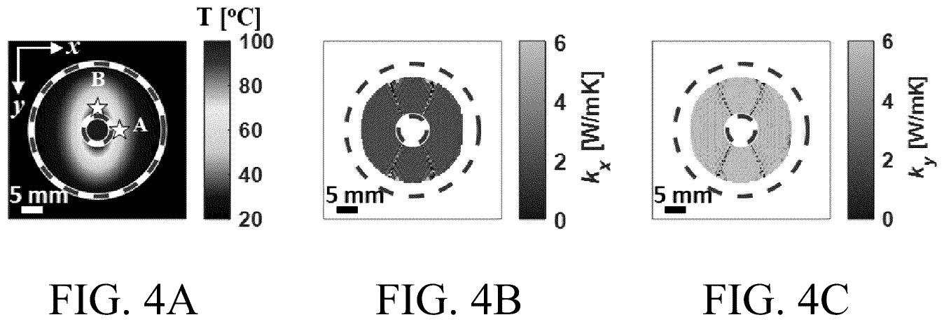

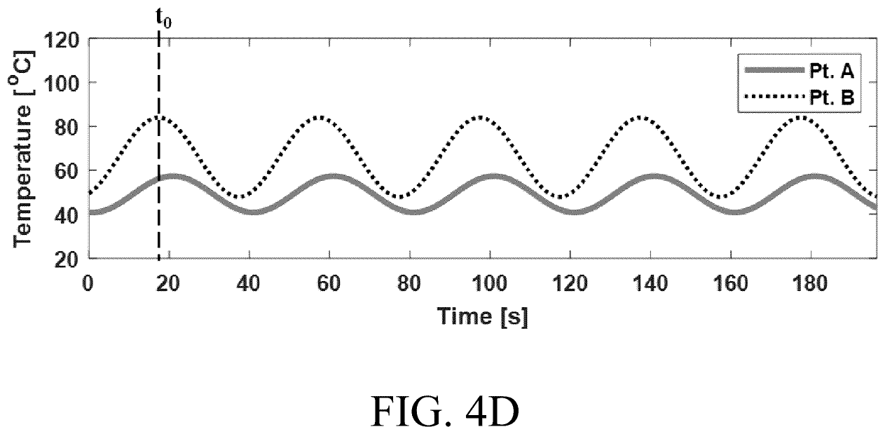

A snapshot of the instantaneous temperature distribution taken at time to over the top surface of the sample, extracted on a square grid from the simulation results, is shown as a contour plot in FIG. 4A. The elliptical isotherms, with higher temperatures at the same distance away from the center in the y direction, indicates the in-plane anisotropy of the sample. The two inner and outer dashed circles represent the boundaries of the domain corresponding to the edge of the metal disk absorber and the edge of the heatsink platform, respectively. The transient temperatures at two points A and B, equidistant from the center of the sample, are plotted in FIG. 4D. The transient profile shown here is the steady periodic temperature response of the material due to the periodic nature of the laser heat input. The temperature profile at point B displays a higher mean temperature and amplitude of oscillations due to the three-times higher in-plane thermal conductivity along the y-direction.

The transient temperature data are used to extract the spatially varying real and imaginary parts of the complex temperature amplitude, P and Q, at each point on the grid as described in subsection V. These are then used to simultaneously solve the discretized forms of Equation 3 and Equation 4 to obtain a map of thermal conductivities kₓ and k_{y} at each grid point, which are plotted in FIGS. 4B and 4C, respectively. Grid points within and near the boundary conditions, such as those inside the region of the absorber and those close to the inner dashed circle (generally within a radial distance 6-7 times the laser spot radius) are excluded from the analysis. In addition, points near the outer dashed circle are also excluded due to the intrinsic noise present in the numerical gradient approximation that becomes significant near boundaries where the geometry and mesh change. These excluded grid points are illustrated in white in FIG. 4B and FIG. 4C.

For the calculated maps of kₓ and k_{y} shown, the average extracted values across all analyzed grid points are kₓ=2.01 W m⁻¹K⁻¹ and k_{y}=6.13 W m⁻¹K⁻¹. However, the calculated standard deviations are high (>100% in each case) due to the nature of the point-by-point computation. At several individual points, the extracted kx and ky have high errors as apparent from the contour plots in FIGS. 4B and 4C that skew the standard deviations. Therefore, while these contour maps are useful to graphically illustrate the computed values of thermal conductivity at each point in the domain, we ultimately consider and recommend a single fit of kx and ky based on the collective data analysis approach as presented in Equation 5. Considering all the included points in the domain to extract single values based on Equation 5 yields kₓ=1.98 W m⁻¹K⁻¹ and k_{y}=6.22 W⁻¹K⁻¹with 95% confidence intervals of (1.975, 1.987) and (6.208, 6.234), respectively. Therefore, for this fictitious anisotropic sample, the in-plane orthotropic thermal conductivities are determined to within 4% of the input values for the numerical simulation model.

### C. Example Measurement Validation Methods for an Isotropic Material

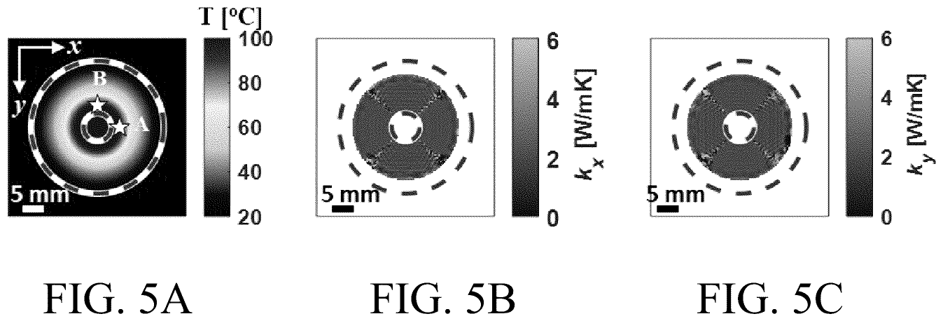

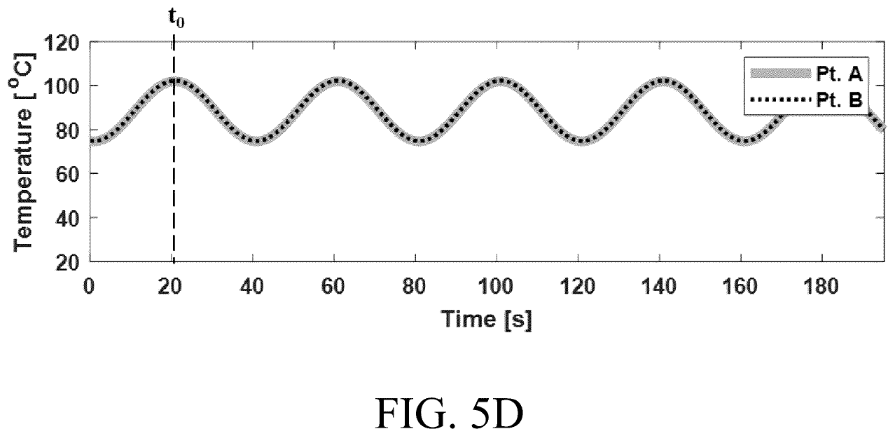

For isotropic materials, numerical experiments are also performed for a sample with equal in-plane orthotropic thermal conductivities of 2 W m⁻¹K⁻¹ in both the x and y directions. All other input parameters match the anisotropic validation case described above. In this isotropic case, the instantaneous surface temperature map, the steady periodic transient response, and the point-by-point calculated maps of kₓ and k_{y} are shown in FIG. 5A-C. The in-plane isotropic nature of the sample is evident from the circular isotherms in FIG. 5A and the overlapping transient temperature traces in the two different coordinate directions in FIG. 5D. The extracted values of kx and ky based on solving the system of equations (Equation 5) are 1.98 and 1.98 W m⁻¹K⁻¹ with confidence intervals of (1.975, 1.982) and (1.977, 1.983), respectively. These agree well with the input thermal conductivity values.

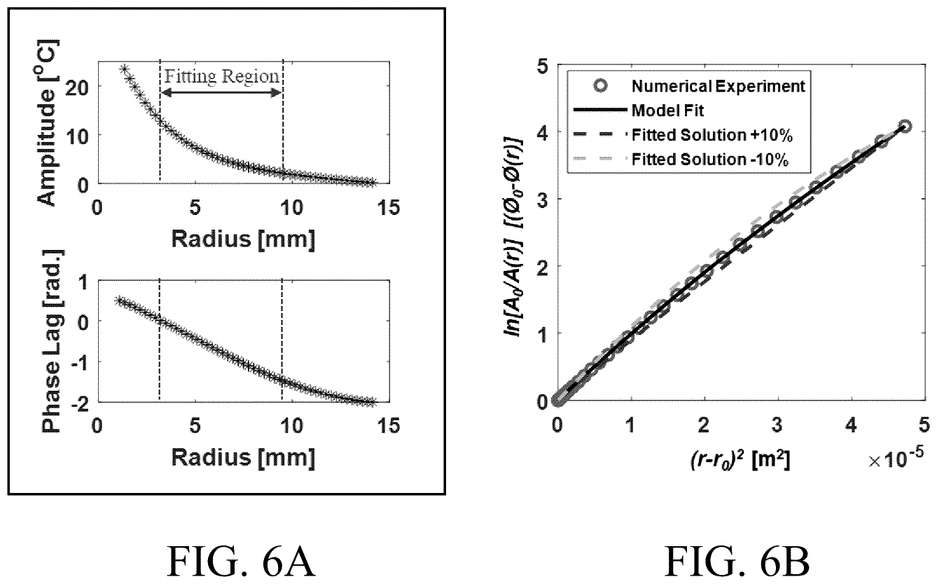

This isotropic case enables validation of the proposed generalized 2D approach for property extraction by allowing for a direct comparison with the 1D radial analytical approach. The same transient temperature data are processed using the analytical solution approach by obtaining the amplitude and phase lag of the temperature oscillations as a function of radial distance from the outer radius of the metal tape disk to the edge of the heatsink platform. This is done by dividing this suspended region of the sample into 50 radial segments and averaging the temperature data within these segments over 360°. This spatially averaged temperature amplitude and phase lag data are plotted in FIGS. 6A and 6B. As expected, the amplitude of the oscillations continuously decreases with increasing radial distance; the magnitude of the phase lag (i.e., negative phase difference) also continuously increases with radial distance. By fitting the combined amplitude and phase parameter φ in the region indicated by the vertical, red-dashed lines in FIG. 6A, the thermal diffusivity of the sample is obtained. These dashed lines correspond to the same radial locations shown by red dashed circles in FIG. 5A. The fitted result is not significantly dependent on the chosen fitting region in this case, provided the starting point is sufficiently away from the inner boundary for the one-dimensional radial heat transfer assumption to hold. The data from the numerical experiment, fitted result, and 10% sensitivity bounds for the fitted solution are plotted in FIG. 5(b). The fitted thermal diffusivity of α=1.06×10⁻⁶ ms⁻¹ corresponds to a thermal conductivity of 1.99 W m⁻¹K⁻¹ , which agrees well with the input value of 2 W m⁻¹K⁻¹ and to the value extracted with the generalized fitting approach.

### IV. Discussion

### A. Measurement Considerations

The numerical experiments and analysis presented above demonstrate the applicability and validity of the proposed method to characterize the in-plane anisotropic thermal properties of a sample based on the known measured transient temperature distribution of the top surface when subjected to periodic heating. The thermal conductivities in the in-plane direction are extracted independent of the laser heat input and the through-plane sample properties.

The main assumption of the property extraction technique is that the heat transfer is two-dimensional in the plane of the sample and that the through plane temperature gradient across the sample thickness H is negligible. This assumption is generally valid when the region of analysis does not include locations close to the laser heat input. However, it is important to quantitatively assess the associated limits of this property extraction method depending on the properties of sample. Specifically, the in-plane versus through-plane thermal properties and the thickness of the sample influence the periodic heating frequency and the dimensions of the experimental setup to be chosen for a particular measurement. By choosing these controllable measurement parameters appropriately, the accuracy of the technique can be maintained over a wide range of thermal properties and length scales.

A primary measurement consideration is the relative through-plane versus in-plane thermal conductance of the sample which also directly relates to the sample thickness H. To minimize the error induced by through-plane temperature gradients of the sample, a sufficiently low frequency could be used such that the sample thickness is much lower than the thermal penetration depth. This condition can be given as

$$f ≪ \frac{{α}_{z}}{π {H}^{2}} , where {α}_{z} = \frac{{k}_{z}}{ρ {C}_{p}} . \qquad hereinafter ( “ Equation 10 ” )$$

Therefore, for a given through-plane conductivity and sample thickness, the input frequency for accurate measurements should be much smaller (i.e., a factor of ˜0.1) compared to this upper bound.

Conversely, the frequency of heating shouldn't be too low and should be sufficiently high to minimize the effect of the boundaries on the in-plane conduction based on the dimensions of the setup. Specifically, the temperature oscillation amplitude should be sufficiently attenuated close to the boundaries, such that the change in the amplitude and phase difference across the suspended region is large. This condition has been defined as:

$$f ≫ \frac{2.98 {α}_{x , y}}{π {L}_{s}^{2}} , where {α}_{x , y} = \frac{{k}_{x , y}}{ρ {C}_{p}} \qquad hereinafter ( “ Equation 11 ” )$$

and Lₛ is the characteristic sample length, which here corresponds to the outer radius of the heatsink platform (characteristic sample length along the radial direction). Depending on the specific sample parameters involved, the measurement frequency can be on the same order of this ideal lower bound.

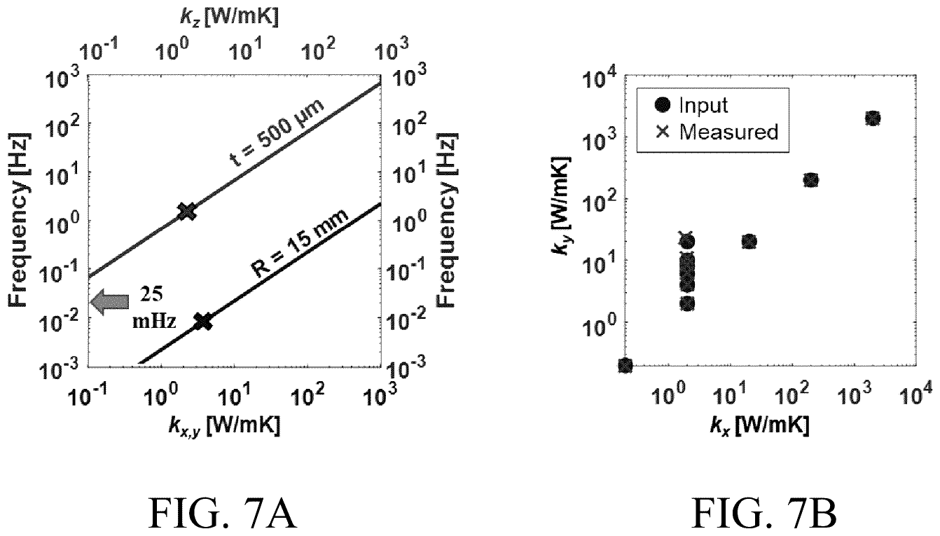

The recommended frequency bounds of 0.01 Hz and 1 Hz described above are graphically illustrated in FIG. 7A for a specific case corresponding to k_{x,y}=4 W m⁻¹K⁻¹, k_{z}=0.5 W m⁻¹K⁻¹, H=500 μm, and R=15 mm. The upper measure frequency bound is dictated by the values of k_{z} and the thickness H, and the lower bound by the values of k_{x,y} and R. In this way, for a given experimental setup, sample geometry, and anticipated thermal properties, the frequency of the periodic heat input can be chosen to lie in the region indicated between these two limits, with an example choice of 25 mHz. This plot serves as a general guideline to assist choice of measurement parameters and understand the limits of the measurement. For example, it is observed from the figure that measurements of a sample with high in-plane conductivity (100 W m⁻¹K⁻¹) and low through-plane conductivity (<0.1 W m⁻¹K⁻¹) would not be feasible for this particular case of sample thickness and outer radius of the setup. This would motivate a measurement facility design change (e.g., a higher R would be needed for such a sample). It is important to note that this plot does not consider the in-plane anisotropy of the sample, a separate and important measurement consideration requiring further analysis to thoroughly understand the complete parametric space associated with this measurement technique.

To demonstrate the tunability of the measurement approach based on the properties of the sample, various numerical experiments are considered with the in-plane orthotropic thermal conductivity of the sample spanning four orders of magnitude from 0.2 W m⁻¹K⁻¹ to 2000 W m⁻¹K⁻¹. In each case, the through-plane thermal conductivity is set to be on the order of 10% of the in-plane thermal conductivity as a representative factor of in-plane to through plane anisotropy. Fixed input values of sample thickness of 0.5 mm, density 970 kg m⁻³, and heat capacity 1950 J kg⁻¹K⁻¹ are assumed. FIG. 7B shows a chart plotting the two in-plane thermal conductivity values against each other over this range, where for each combination the numerical experiment inputs are compared to the extracted properties. For each pair of data points plotted, the input laser power and heating frequency are adjusted following the guidelines above to accurately capture the in-plane thermal conductivities. As an example, a heating power of 5×10⁵ W m² and a frequency of 25 mHz are used for the case of kₓ, k_{y}=2 W m⁻¹K⁻¹, while a heating power of 1*10⁸ W m⁻² at a frequency of 10 Hz are used for the case of kₓ, k_{y}=2000 W m⁻¹K⁻¹. The agreement between the input and extracted conductivity values is within 1% for cases where kₓ=k_{y} across the broad range of thermal conductivity considered. Also, for a fixed kₓ=2 m⁻¹K⁻¹, an in-plane anisotropic ratio of up to 10 (2k_{y}20 W m⁻¹K⁻¹) is accurately predicted to within an average error 10%. The error for anisotropic ratios in the range of 1 to 8 is within 5% of error, increasing to ˜10% for an anisotropic ratio of 10. This increase in error with increasing anisotropy is mainly related to increased relative differences in temperature oscillations and phase lag along the primary in-plane directions, which are captured with lesser accuracy for a given value of heating frequency. Conducting multiple sets of experiments spanning a frequency range and extracting a single property value that best fits the temperature response across this entire range, can potentially be used to reduce this error for highly anisotropic (in-plane) materials. However, for the current approach using a single measurement frequency, an anisotropic ratio of 10 can be considered as a conservative upper bound; such high anisotropic ratios in the in-plane direction are nevertheless atypical.

### B. Effect of Convective Losses

Another important consideration for this measurement technique is the effect of heat loss due to convection. This can be trivially accounted for in the governing equation by including a heat loss term in Equation 1:

$$\frac{\partial }{\partial x} ( {k}_{x} \frac{\partial T}{\partial x} ) + \frac{\partial }{\partial y} ( {k}_{y} \frac{\partial T}{\partial y} ) - \frac{2 h ( T - {T}_{∞} )}{H} = ρ {C}_{p} \frac{\partial T}{\partial t} . \qquad hereinafter ( “ Equation 12 ” )$$

where H is the thickness of the material, and h is the heat transfer coefficient assumed to be uniform and constant over both upper and lower surface of the sample. This results in a modified form of the system of governing equations to fit for kₓ and k_{y} as:

$${[ \begin{matrix}\frac{{\partial }^{2} {P}_{1}}{\partial {x}^{2}} & \frac{{\partial }^{2} {P}_{1}}{\partial {y}^{2}} \\ … & … \\ … & … \\ \frac{{\partial }^{2} {Q}_{1}}{\partial {x}^{2}} & \frac{{\partial }^{2} {Q}_{1}}{\partial {y}^{2}} \\ … & … \\ … & …\end{matrix} ]}_{2 n \times 2} [ \begin{matrix}{k}_{x} \\ {k}_{y}\end{matrix} ] = {[ \begin{matrix}\frac{2 {hP}_{1}}{H} - ρ {C}_{p} ω {Q}_{1} \\ … \\ … \\ \frac{2 {hQ}_{1}}{H} + ρ {C}_{p} ω {P}_{1} \\ … \\ …\end{matrix} ]}_{2 n \times 1} . \qquad hereinafter ( “ Equation 13 ” )$$

The system of equations can be solved by fitting for kₓ, k_{y} with an input estimate of the convection coefficient, h. Equation 13 also illustrates another tunable aspect of this measurement technique based on the frequency of operation. For a particular sample, depending on the order of sample thermal conductivity, the frequency can be increased such that the term 2P₁/H it becomes negligible compared to the term ρCₚωQ₁ in Equation 13. In such a scenario, sample properties can be extracted independent of the effect of convection.

Alternatively, for materials and ambient conditions where the influence of the convective heat transfer co-efficient cannot be ignored, all three parameters, kₓ, k_{y}, and h can be estimated based on a three parameter least squares fit as:

$${[ \begin{matrix}\frac{{\partial }^{2} {P}_{1}}{\partial {x}^{2}} & \frac{{\partial }^{2} {P}_{1}}{\partial {y}^{2}} & \frac{- 2 {P}_{1}}{H} \\ … & … & \\ … & … & \\ \frac{{\partial }^{2} {Q}_{1}}{\partial {x}^{2}} & \frac{{\partial }^{2} {Q}_{1}}{\partial {y}^{2}} & \frac{- 2 {Q}_{1}}{H} \\ … & … & \\ … & … & \end{matrix} ]}_{2 n \times 3} [ \begin{matrix}{k}_{x} \\ {k}_{y} \\ h\end{matrix} ] = {[ \begin{matrix}- ρ {C}_{p} ω {Q}_{1} \\ … \\ … \\ ρ {C}_{p} ω {P}_{1} \\ … \\ …\end{matrix} ]}_{2 n \times 1} . \qquad ( hereinafter “ Equation 14 ” )$$

Further, if values of ρ and cₚ are unknown, Equation 14 could be divided by the term ρcₚ and the thermal diffusivity values αₓ, α_{y} and (h/ρcₚ) can be fit directly.

### C. Experimental Characterization and Validation

Here, an experimental demonstration of the proposed measurement method is presented for an isotropic and anisotropic material. The isotropic material is a polyeflurotetraethylene (PTFE) sheet and the anisotropic material is an engineered polymer heat spreading sheet (e.g., a Temprion Organic Heat Spreader (OHS) manufactured by DuPont de Nemours, Inc of Wilmington, DE). While the PTFE is a well-known isotropic material, the Temprion OHS material exhibits an extreme case of in-plane anisotropy among available materials. Experimental results for these two materials are described in greater detail below.

### i. Thermal Characterization of PTFE

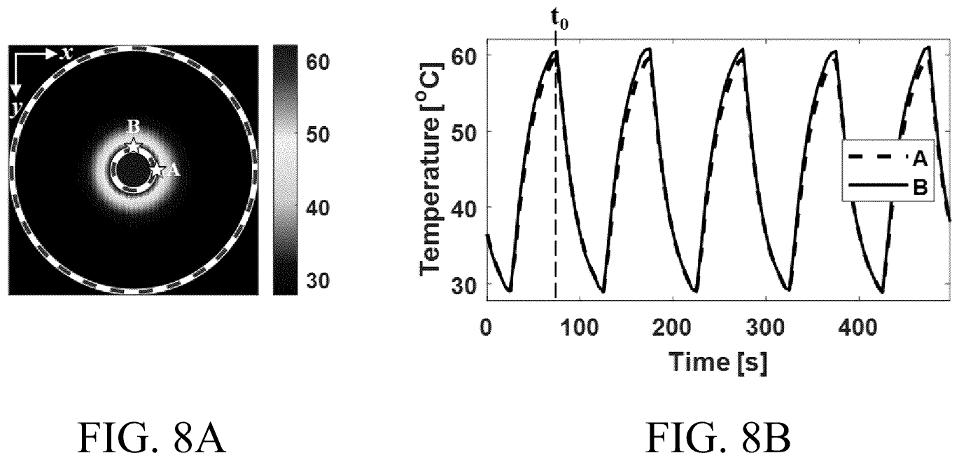

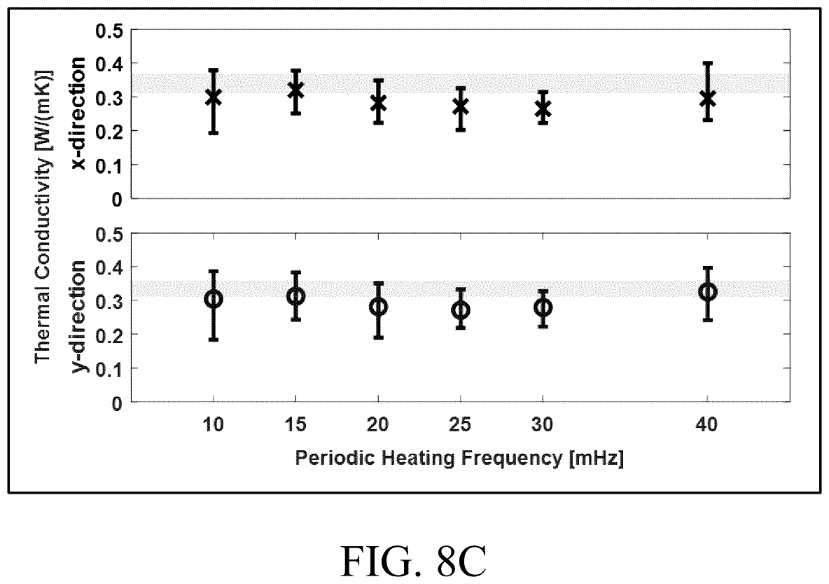

Polytetrafluroethylene (PTFE) is a common material that has well characterized thermal properties, making it a candidate for use as a reference material for measurement technique development. FIG. 8A shows the experimentally measured 2D temperature profile in a 500 μm thick PTFE sample at a fixed time instant t₀, and FIG. 8B shows the transient temperature response at two spatial locations A and B for a few heating cycles at steady periodic conditions. Thermal isotropy is not assumed in the measurement analysis and kₓ and k_{y} are fit independently. However, because the material is expected to have isotropic thermal properties, the x and y directions are assigned arbitrarily. The density and specific heat of PTFE are 2200 m³kg⁻¹ and 970 J kg⁻¹K⁻¹ respectively. FIG. 8C shows the measured thermal conductivity values along the x and y directions, as a function of heating frequency. The symbols signify the mean value of thermal conductivity, while the error bars show the uncertainty in the measurement originating from the thermal image processing and data analysis. The mean values of kₓ and k_{y} are 0.29±0.02 and 0.29±0.03W m⁻¹K⁻¹ respectively, approximately centered within the range of the expected thermal conductivity for PTFE as indicated by the shaded horizontal bands in the figure. The equal values of kₓ and k_{y} confirms the isotropic behavior of this material.

### ii. Thermal Characterization of the Anisotropic Dupont Temprion Organic Heat Spreader

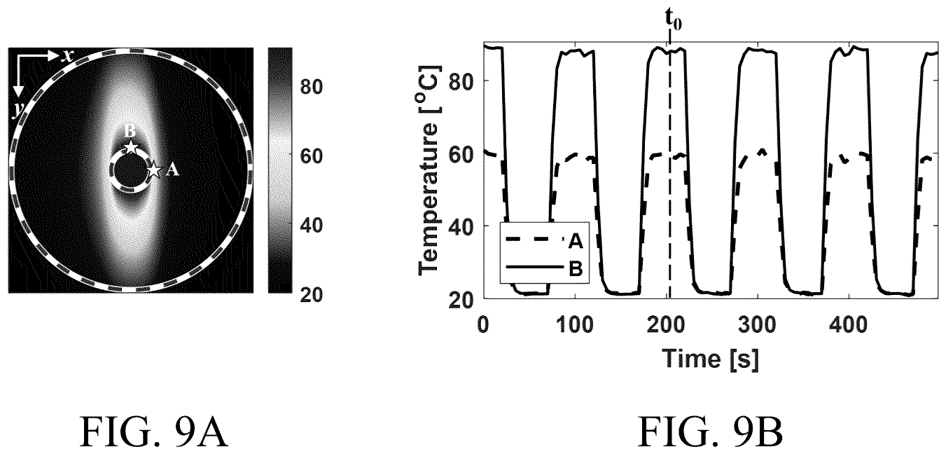

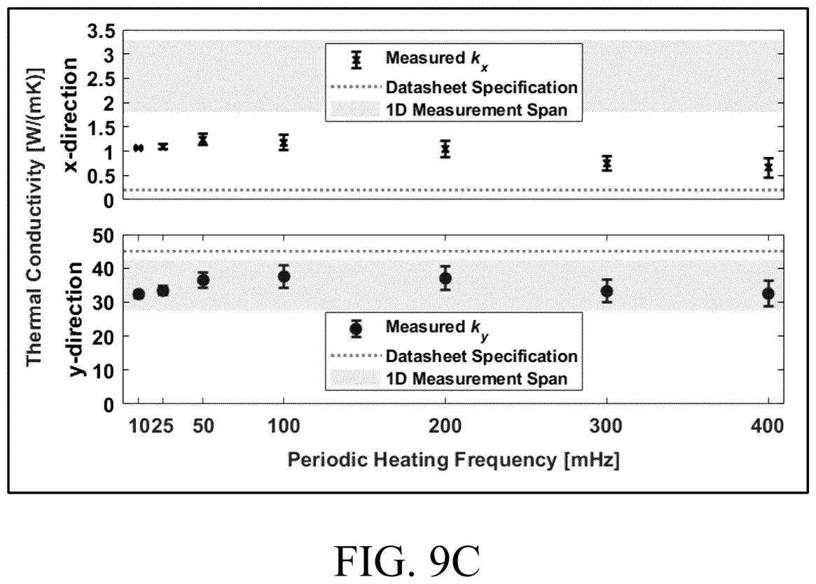

The Temprion Organic Heat Spreader (OHS) material is an electrically insulating flexible polymeric thin film of thickness 45 μm that is used for heat spreading applications. It exhibits a high degree of in-plane and through-plane thermal anisotropy. The manufacturer-specified values of thermal conductivity in the three orthotropic directions, kₓ, k_{y} and kₓ, are 0.2, 45 and 0.2 W m⁻¹K⁻¹ respectively. The two in-plane x and y directions are referred to as the transverse and machine directions, respectively, and z being along the through-plane direction. This translates to an in-plane anisotropy ratio (k_{machine}/kₜᵣₐₙₛᵥₑᵣₛₑ) of 225. The density and specific heat of this material is 1500 m³kg⁻¹ and 1000 J kg⁻¹K⁻¹ respectively. During characterization, the material was mounted such that the low-conductivity transverse and high conductivity machine direction was aligned with the x and y coordinate system of the thermal imaging sensor on the IR microscope. FIG. 9A shows a snapshot of the 2D temperature distribution at a single time instant. The elliptical isotherms indicate higher thermal diffusion in y-direction. The corresponding transient temperature profiles for a few time-periodic cycles at two points A and B are shown in FIG. 9B. Note the decay in amplitude of temperature oscillations along the x-direction (dotted black curve), compared to the y-direction (solid black curve). FIG. 9C shows the experimentally measured values of kₓ and k_{y}, across a range of heating frequencies. The mean thermal conductivity in the transverse direction is kₓ1.0±0.3 W m⁻¹K⁻¹ and in the machine direction is k_{y}=37.5±2.6 W m⁻¹K⁻¹. Although the measured mean conductivity value in the x-direction is higher than the specification on the data sheet, and that in the y-direction is lower, this difference is expected due to the variability in the material itself, which stems from batch-to-batch construction and processing. Numerical experiments have also been performed for this material, and the extracted thermal conductivity in the transverse and machine direction agrees well with the input properties.

To independently verify the measured value of kx and ky for Temprion OHS using an established technique, narrow strip-like samples were created and characterized using the IR-enhanced one-dimensional version of the Ångstrom's method. Briefly, the measured mean thermal conductivity for a sample cut in the traverse direction is kₓ=2.5±0.8 W m⁻¹ K⁻¹ and that for a sample cut in the machine direction is k_{y}=37.1±7.3 W m⁻¹K⁻¹. Although the value for k_{y}, as measured independently using traditional 1-D Ångstrom method matches almost exactly with that measured with the 2-D Laser Ångstrom method, there is a significant difference in the kₓ value. A second 1D sample measured along the traverse direction yielded a thermal conductivity value of 2.0±0.5 W m⁻¹K⁻¹. It is likely that these differences are due to variation in the material properties between the samples or directional nature of the density and specific heat.

### D. Example Measurement Workflows

Several parameters associated with the sample geometry and the measurement technique can be optimized for accurate measurements. For purposes of the following discussion, fixed parameters are assumed outside of the control of the technique are the density (ρ), specific heat (Cp), and thickness (H) of the sample. Unknown material properties include the through-plane thermal conductivity (k_{z}) and the to-be-measured thermal conductivity in the in-plane directions (kₓ and k_{y}). It is presumed that some initial estimates of the order of magnitude of these expected thermal conductivity values (or the desired range to be measurable) are known a priori or the process described here may require iterations. Tuning parameters in the measurement include the frequency of heating (fₑᵥₐₗ) and the radius of the heat sink (R_{HS}), which must be chosen to ensure accurate results.

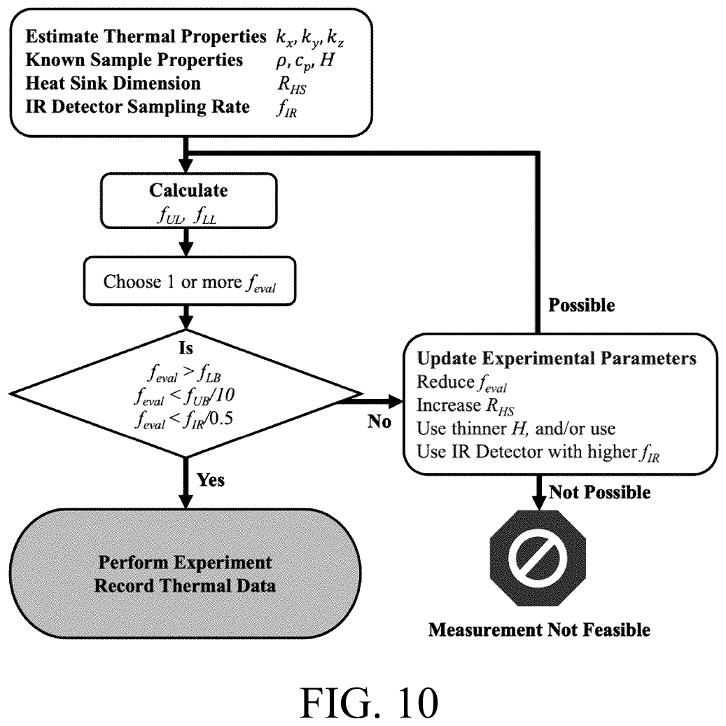

One standardized, step-wise workflow for measuring the in plane thermal conductivity of unknown samples in an experimental facility with a heat sink radius of R_{HS} and using an IR detector with a refresh rate of f_{IR,d} is graphically shown in FIG. 10 and generally includes the following steps. First, measuring the thickness and, if possible, the density and heat capacity, of the sample. Second, utilizing the estimated or measured material properties (kₓ, k_{y}, k_{z}, ρ, Cp, and H), calculate the upper limit (f_{UL}=α_{z}/(πH²)) and the lower limit (f_{LL}=2.98 max (kₓ, k_{y})/(πL_{S}²)). While this lower frequency is not a physical limit that affects measurement accuracy, it serves as a proxy for the practical limit of measurement duration. Third, proposing one or more heating frequencies, feval, between the upper and lower limits for measurement, and check the following conditions are met: (1) feval is greater than fLL; (2) fₑᵥₐₗ is at least ten times smaller than fUL; and (3) feval is at least two times smaller than fIR. Fourth, if these conditions are met, the sample can be measured at the selected fₑᵥₐₗ and data can be recorded for further analysis. If any of the above conditions are not met, experimental parameters may need to be changed: fₑᵥₐₗ may need to be reduced, the sample might need to be made larger and suspended over a larger R_{US}, be made thinner, or an IR detector with a higher refresh rate may be needed. If none of these changes can be made (due to constraints on the experimental system or sample fabrication process) or no favorable set of fₑᵥₐₗ are possible, measurement of the sample may not be feasible. Fifth, after the temperature data are recorded at fₑᵥₐₗ proceed to extract kₓ and k_{y}.

### E. Example Data Analysis Workflows

After temperature data are recorded from an experiment, they can be analyzed to extract the unknown thermal conductivities: kₓ and k_{y}. This section provides example steps for doing so. If data are measured by an IR camera without built-in lock-in detection, the spatiotemporal temperature profiles, \tilde{T}(x, y, t), must first be processed using Fourier Transforms to obtain the temperature amplitude, \tilde{T}(x, y), and phase delay, φ_{d}(x, y) or in-phase, P, and out-of-phase, Q, components of the signal. If lock-in thermography is used, \tilde{T}(x, y) and φ_{d}(x, y) may be imported directly from the measurement.

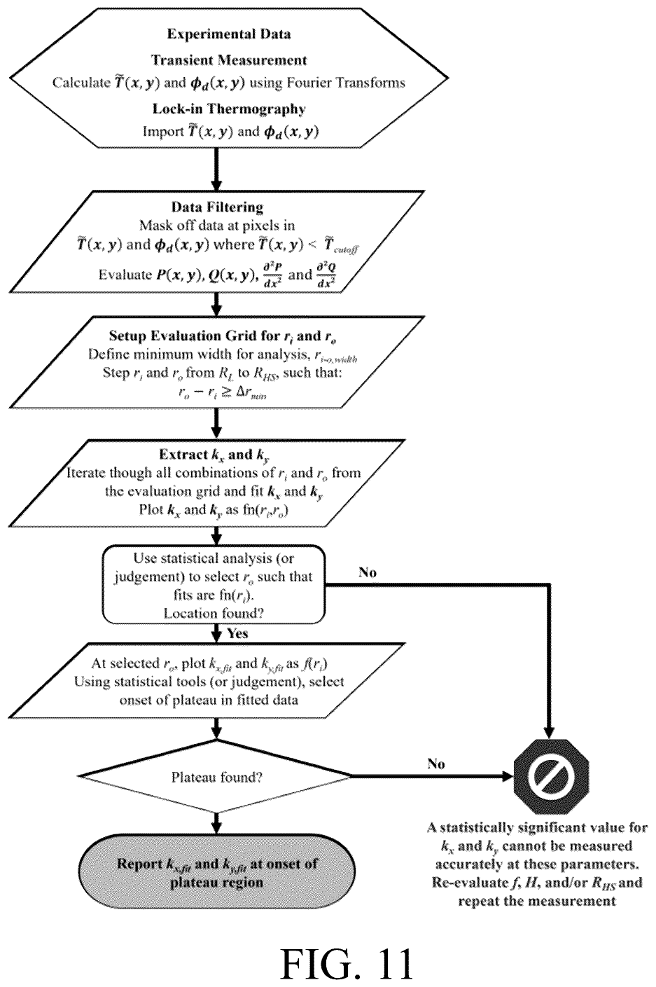

To accurately extract kₓ and k_{y}, a subset of the temperature data must be identified within the suspended region of the sample. Briefly, the region for analysis must have sufficient amplitudes of oscillation compared to the noise floor, sufficient changes in amplitude and phase for data fitting, and negligible changes in temperature response through the thickness of the sample (minimal 3D effects). These criteria help define the inner, rᵢ, and outer, rₒ, radii for data analysis. This process of analyzing data is graphically illustrated in FIG. 11.

High spatial resolution measurement of the temperature at the top surface of the sample allows for analysis of different regions of the sample to verify the appropriate selection of rᵢ and rₒ. For a sample that conducts heat radially outward toward the heat sink in response to periodic heating at the center, data may be analyzed in circular concentric annular regions defined by rᵢ and rₒ, even when the material is anisotropic. A minimum width of the annular region for analysis is defined, Δrₘᵢₙ, with sufficient pixels for trends in magnitude and phase to be observed.

Accordingly, described above is a new technique for the characterization of the in-plane thermal conductivity of both isotropic and anisotropic materials across a wide range of properties and in-plane anisotropy ratios. This technique takes inspiration from the Ångstrom method to enable characterization of thin films and sheets. This measurement implements non-contact infrared imaging and laser heating, and the thermal conductivity of the material is calculated without the measurement of the input heating power, which helps reduce uncertainty. Numerical experiments validated the accuracy of the technique and demonstrate its applicability for both known and hypothetical materials up to high in-plane anisotropic ratios. Another salient feature of this technique is that the thermal conductivity in the two orthotropic directions can be measured simultaneously in a single measurement of one sample, versus existing techniques that would require preparing multiple samples for each direction of interest. Finally, this measurement technique is demonstrated and validated by conducting experiments using an isotropic reference material and a commercially available anisotropic material. Through both physical and numerical experiments, it has been demonstrated that this technique can be used to characterize novel materials with very high in-plane anisotropy ratios. The present work validated the technique for materials spanning a range of 0.1-2000 W m⁻¹K⁻¹, and in-plane anisotropy ratios of up to 225, which is higher than most other lock-in thermography techniques, and TDTR- and FDTR-based measurement approaches.

This technique is versatile, robust, and straightforward to execute. Other than the application of a thin layer of graphite to increase emissivity, if necessary (e.g., for semi-transparent or reflective samples), no special processing of the sample is required before the measurement. The measurement setup could be fabricated using low cost, small form factor infrared cameras (instead of an infrared microscope) and small diode lasers for a compact benchtop system. The additional hardware required to execute experiments using this technique is easily accessible. The metrology tool is straightforward and does not involve intricate assembly, precise optical alignment, scanning of the laser beam, or deposition of a thin metal transducer layer unlike some other existing laser based and pump probe methods. The system can accommodate a wide range of sample properties and geometries. Specifically, the frequency of periodic heating is one of the tuning parameters in this technique that allows characterization of samples across a range of thicknesses. Furthermore, the experimental setup dimensions can be modified to accommodate and measure materials across a wide spectrum of in-plane properties.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A system for measuring a property of a material sample, comprising:
(a) a heatsink configured to support a material sample at a fixed position thereon, wherein the heatsink is configured to maintain a preconfigured contact temperature with the material sample, wherein the heatsink includes an opening therethrough to suspend a portion of the material sample;
(b) a heat source positioned adjacent to the heatsink and configured to direct an input heat signal at a fixed position toward the portion of the material sample, wherein the heat source is operable to selectively tune a frequency and a power level of the input heat signal; and
(c) a first two-dimensional transient thermal imaging system positioned adjacent to the heatsink, wherein the first two-dimensional transient thermal imaging system is configured to generate a resultant two-dimensional transient temperature distribution dataset associated with the material sample upon the heat source directing the input heat signal toward the portion of the material sample to heat the material sample.

2. The system of claim 1, wherein the heat source includes a laser source and the input heat signal includes an input laser beam, wherein the laser source is operable to selectively tune the frequency and power of the input laser beam.

3. The system of claim 2, wherein the input laser beam includes a periodic laser signal.

4. The system of claim 2, comprising at least one mirror configured to receive the input laser beam and direct the input laser beam from the laser source toward the opening.

5. The system of claim 1, comprising a metallic laser absorber configured to affix to the material sample adjacent to the opening of the heatsink, wherein the input heat signal is directed onto the metallic laser absorber.

6. The system of claim 5, wherein the metallic laser absorber includes a graphite coated circular metal disk.

7. The system of claim 1, comprising a vacuum chamber, wherein the heatsink is positioned within the vacuum chamber.

8. The system of claim 1, wherein the first two-dimensional transient thermal imaging system includes an infrared camera system.

9. The system of claim 1, comprising a second two-dimensional transient thermal imaging system positioned adjacent to the heatsink, wherein the second two-dimensional transient thermal imaging system is configured to generate a second resultant two-dimensional transient temperature distribution dataset associated with the material sample upon the heat source directing the input heat signal onto the portion of the material sample, wherein the second two-dimensional transient thermal imaging system is configured to image an opposite side of the material sample relative to the first two-dimensional transient thermal imaging system.

10. A method of measuring a property of a material sample using a measurement system, wherein the measurement system includes a heatsink defining an opening therethrough, a heat source positioned adjacent to the heatsink and configured to direct an input heat signal toward the opening, and a two-dimensional transient thermal imaging system, the method comprising:
(a) positioning the material sample onto a surface of the heatsink;
(b) directing the input heat signal toward the opening to heat a portion of the material sample; and
(c) using the two-dimensional transient thermal imaging system, generating a resultant two-dimensional transient temperature distribution dataset associated with the material sample upon the heat source directing the input heat signal toward the opening to heat the material sample.

11. The method of claim 10, comprising:
extracting a frequency domain dataset from the resultant two-dimensional transient temperature distribution dataset.

12. The method of claim 11, comprising:
extracting at least one thermal property characterization of the material sample from the frequency domain dataset.

13. The method of claim 10, wherein directing the input heat signal toward the opening to heat a portion of the material sample includes directing a periodic laser signal toward the opening.

14. The method of claim 10, wherein directing the input heat signal toward the opening to heat a portion of the material sample includes positioning a mirror into the path of the input heat signal to direct the input heat signal toward the opening.

15. The method of claim 10, comprising:
coupling a metallic laser absorber with the material sample adjacent to the opening of the heatsink.

16. A system for measuring a property of a material sample, comprising:
(a) a vacuum chamber;
(b) a heatsink positioned within the vacuum chamber and configured to support a material sample at a fixed position thereon, wherein the heatsink is configured to maintain a preconfigured contact temperature with the material sample;
(c) a heat source positioned adjacent to the heatsink and configured to direct an input heat signal at a fixed position onto the material sample; and
(d) a first two-dimensional transient thermal imaging system positioned adjacent to the heatsink, wherein the first two-dimensional transient thermal imaging system is configured to generate a resultant two-dimensional transient temperature distribution dataset associated with the material sample upon the heat source directing the input heat signal onto the material sample.

17. The system of claim 16, wherein:
the heatsink includes an opening therethrough; and
the heat source is configured to direct the input heat signal through the opening to heat a portion of the material sample.

18. The system of claim 16, wherein the heat source is operable to selectively tune a frequency and a power level of the input heat signal.

19. The system of claim 16, comprising a second two-dimensional transient thermal imaging system positioned adjacent to the heatsink, wherein the second two-dimensional transient thermal imaging system is configured to generate a second resultant two-dimensional transient temperature distribution dataset associated with the material sample upon the heat source directing the input heat signal onto the material sample.

20. The system of claim 19, wherein the second two-dimensional transient thermal imaging system is configured to image an opposite side of the material sample relative to the first two-dimensional transient thermal imaging system.
